(19) United States
(12) Patent Application Publication
(10) Pub. No.: US 2026/0034787 A1
(43) Pub. Date: Feb. 5, 2026

(54) INKJET RECORDING APPARATUS

(71) Applicant: KYOCERA Document Solutions Inc., Osaka (JP)

(72) Inventor: Yuko YANO, Osaka (JP)

(73) Assignee: KYOCERA Document Solutions Inc., Osaka (JP)

(21) Appl. No.: 19/276,675

(22) Filed: Jul. 22, 2025

(30) Foreign Application Priority Data
Jul. 30, 2024 (JP) 2024-123557

(51) Int. Cl. B41J 2/17; B41J 11/00

(52) U.S. Cl. CPC B41J 2/1714; B41J 2/1707; B41J 2/1742; B41J 11/007

(57) ABSTRACT

The inkjet recording apparatus includes a recording head, a waste ink container and a suction mechanism. The waste ink container includes a reception hole for receiving ink ejected from the recording head, a suction hole connected to the suction mechanism, and a suction airflow path which communicates the reception hole and the suction hole with each other. The suction airflow path includes a reverse airflow path for leading a suction airflow in a direction of further separation from the suction hole, and a forward airflow path for leading the suction airflow in a direction of further nearness to the suction hole.

### INCORPORATION BY REFERENCE

This application is based on and claims the benefit of priority from Japanese Patent Application No. 2024-123557 filed on Jul. 30, 2024, the contents of which are hereby incorporated by reference.

### BACKGROUND

The present disclosure relates to an inkjet recording apparatus.

Conventional inkjet recording apparatuses are equipped with a waste ink container for storing ink destined for disposal.

The waste ink container is connected to a suction mechanism. The suction mechanism sucks gas from the waste ink container. The gas sucked by the suction mechanism flows along a flow path provided inside the waste ink container. It is noted that the gas contains misty ink.

### SUMMARY

An inkjet recording apparatus according to the present disclosure includes a recording head, a waste ink container and a suction mechanism. The recording head ejects ink to a recording medium, which is being conveyed toward one side of a first direction, to record an image. The waste ink container, which is placed so as to be opposed in a second direction to the recording head with a conveyance path for the recording medium interposed therebetween, internally has a storage area to store the ink, which has been ejected from the recording head, in the storage area. The suction mechanism sucks a gas from the waste ink container. The waste ink container includes a reception hole, a suction hole and a suction airflow path. The reception hole receives the ink ejected from the recording head. The suction hole, which is placed at a position separate by a spacing from the reception hole as viewed in the second direction, is connected to the suction mechanism. The suction airflow path communicates with the reception hole and the suction hole so as to allow a suction airflow generated by drive of the suction mechanism to pass therethrough. The suction airflow path has, as viewed in the second direction, a reverse airflow path for leading the suction airflow in a direction of further separation from the suction hole, and a forward airflow path for leading the suction airflow in a direction of further nearness to the suction hole.

### BRIEF DESCRIPTION OF THE DRAWINGS

FIG. 1 is a schematic view of an inkjet recording apparatus according to an embodiment;

FIG. 2 is a plan view of a recording part of the inkjet recording apparatus according to the embodiment;

FIG. 3 is a block diagram of the inkjet recording apparatus according to the embodiment;

FIG. 4 is a plan view of a conveyor belt of the inkjet recording apparatus according to the embodiment;

FIG. 5 is a schematic view of around the conveyor belt of the inkjet recording apparatus according to the embodiment;

FIG. 6 is a schematic perspective view of around the conveyor belt of the inkjet recording apparatus according to the embodiment (a view showing a state in which all of waste ink containers are set up);

FIG. 7 is a schematic perspective view of around the conveyor belt of the inkjet recording apparatus according to the embodiment (a view showing a state in which part of the waste ink containers are removed);

FIG. 8 is a perspective view of a waste ink container in the inkjet recording apparatus according to the embodiment;

FIG. 9 is a plan view of the waste ink container in the inkjet recording apparatus according to the embodiment;

FIG. 10 is a perspective view of the waste ink container shown in FIG. 8 with its ceiling portion omitted;

FIG. 11 is a perspective view of an absorption member in the inkjet recording apparatus according to the embodiment;

FIG. 12 is a view schematically showing a suction airflow path connected to a central reception hole in the inkjet recording apparatus according to the embodiment;

FIG. 13 is a view schematically showing a suction airflow path connected to a front-side reception hole in the inkjet recording apparatus according to the embodiment;

FIG. 14 is a view schematically showing a suction airflow path connected to a rear-side reception hole in the inkjet recording apparatus according to the embodiment;

FIG. 15 is a plan view of a fifth absorption layer in the inkjet recording apparatus according to the embodiment;

FIG. 16 is a plan view of a fourth absorption layer in the inkjet recording apparatus according to the embodiment;

FIG. 17 is a plan view of a third absorption layer in the inkjet recording apparatus according to the embodiment;

FIG. 18 is a plan view of a second absorption layer in the inkjet recording apparatus according to the embodiment;

FIG. 19 is a plan view of a first absorption layer in the inkjet recording apparatus according to the embodiment;

FIG. 20 is a conceptual view of a turbulent-flow generation area in the inkjet recording apparatus according to the embodiment; and

FIG. 21 is a sectional view taken along a line A-A′ of FIG. 13.

### DETAILED DESCRIPTION

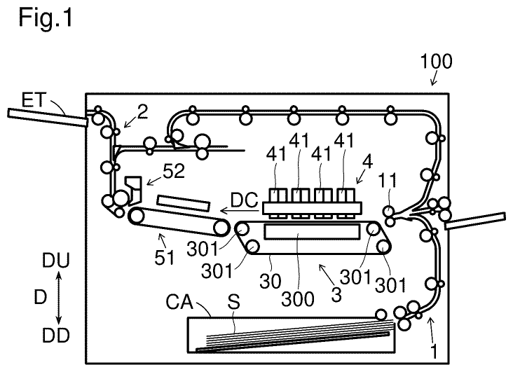

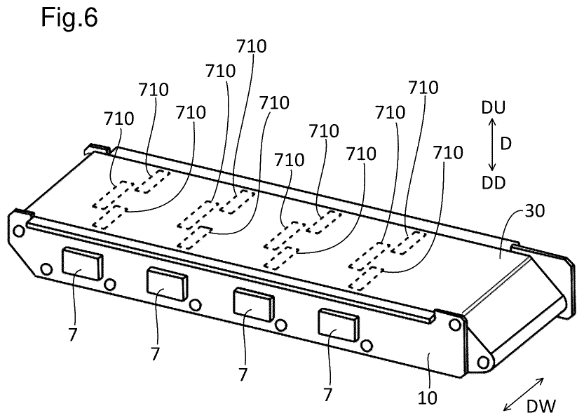

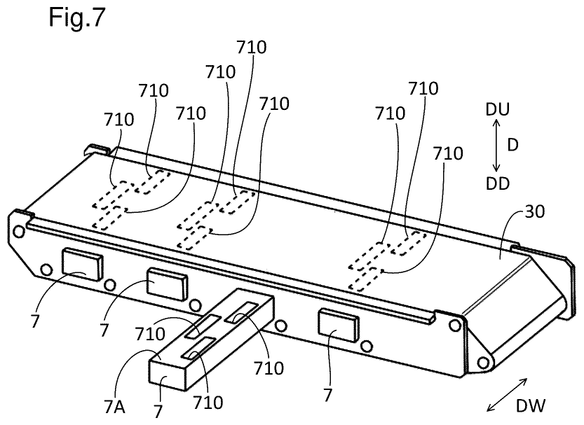

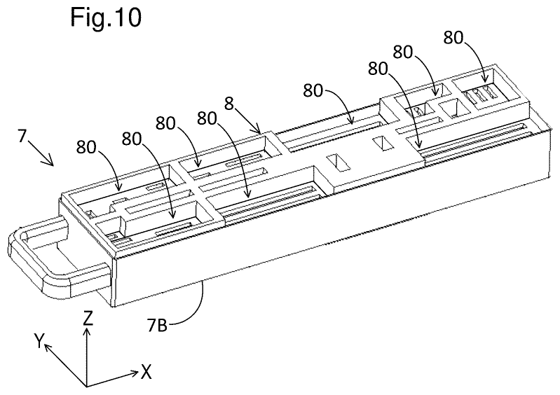

Hereinafter, an embodiment of the present disclosure will be described with reference to FIGS. 1 to 21 by taking an inkjet type printer 100 as an example. The printer 100 is installed on a flat floor surface and put into use in that state. Hereinafter, a direction perpendicular to a flat floor surface on which the printer 100 is installed (the direction being a vertical direction) is defined as an up/down direction of the printer 100. In the figures for reference in the following description, a direction indicated by sign D is the up/down direction, where arrow DU indicates upper side, and arrow DD indicates lower side.

The printer 100 prints (i.e., records) an image on a sheet S. The sheet S is equivalent to ‘recording medium’. The sheet S is given mostly by a paper sheet. Other sheets S such as OHP sheets are also usable. Further, cloth, corrugated cardboard and the like may be used as well.

### Configuration of Printer

As shown in FIG. 1, the printer 100 (equivalent to ‘inkjet recording apparatus’) of this embodiment includes a first conveyance part 1 and a second conveyance part 2. The first conveyance part 1 feeds a sheet S (equivalent to ‘recording medium’) set on a sheet feed cassette CA, conveying the sheet S toward a print position. For a print job by the printer 100, printing of an image is executed onto the sheet S passing through the print position. In the figures for reference in the following description, a direction indicated by sign DC is a conveyance direction of the sheet S. The second conveyance part 2 conveys the printed sheet S. The second conveyance part 2 discharges the printed sheet S onto a discharge tray ET.

The first conveyance part 1 includes a plurality of conveyance roller members including a registration roller pair 11. In FIG. 1, among the plurality of conveyance roller members, only the registration roller pair 11 has a sign added thereto. The plurality of conveyance roller members are each rotated to convey the sheet S. The registration roller pair 11 includes a pair of rollers set into mutual pressure contact. The pair of rollers form a registration nip therebetween. The sheet S fed from the sheet feed cassette CA comes into the registration nip. The registration roller pair 11 are rotated to convey the sheet S, which has come into the registration nip, toward a later-described belt conveyance part 3.

At a time point when a forward end of the sheet S has reached the registration nip, the registration roller pair 11 is at a halt of rotation. Meanwhile, the conveyance roller members placed upstream of the registration roller pair 11 in the conveyance direction of the sheet S are in rotation. As a result of this, any feed skew of the sheet S is corrected.

The printer 100 includes a belt conveyance part 3. The belt conveyance part 3 receives the sheet S from the first conveyance part 1 to do further conveyance. The belt conveyance part 3 includes a conveyor belt 30. The conveyor belt 30 is endless and rotatably supported. The belt conveyance part 3 also includes a plurality of stretching rollers 301. The plurality of stretching rollers 301 are rotatably supported. The conveyor belt 30 is stretched by the plurality of stretching rollers 301 so as to be rotatable. The sheet S conveyed up from the first conveyance part 1 reaches an outer circumferential surface of the conveyor belt 30.

One of the plural stretching rollers 301 is coupled to a belt motor (not shown) so that driving force of the belt motor is transmitted to the one stretching roller 301, enabling its rotation. The rotation of the stretching roller 301 coupled to the belt motor causes the conveyor belt 30 to be rotated subordinately. In this situation, the other stretching rollers 301 are also rotated subordinately.

The belt conveyance part 3 further includes a suction unit 300. The suction unit 300 is placed on an inner circumferential side of the conveyor belt 30. The suction unit 300 sucks up the sheet S on the outer circumferential surface of the conveyor belt 30.

More specifically, the conveyor belt 30 has a plurality of suction holes (not shown). Each suction hole of the conveyor belt 30 extends through the conveyor belt 30 in its thicknesswise direction. The suction unit 300 sucks up the sheet S via the suction holes of the conveyor belt 30. As a result, the sheet S is absorbedly sucked to the outer circumferential surface of the conveyor belt 30. The conveyor belt 30 is rotated while sucking and holding the sheet S to the outer circumferential surface. As a consequence, the sheet S is conveyed. That is, the conveyor belt 30 conveys the sheet S while sucking up the sheet S onto the outer circumferential surface.

The printer 100 includes a recording part 4. The recording part 4 is placed so as to be opposed to the outer circumferential surface of the conveyor belt 30 in the up/down direction. During conveyance of the sheet S, the sheet S laid on the outer circumferential surface of the conveyor belt 30 and the recording part 4 are opposed to each other with a space provided therebetween in the up/down direction. As a result, the sheet S, during its conveyance, passes through a space between nozzle surfaces of later-described recording heads 40 and the outer circumferential surface of the conveyor belt 30. That is, the space between the nozzle surfaces of the recording heads 40 and the outer circumferential surface of the conveyor belt 30 forms part of a conveyance path of the sheet S.

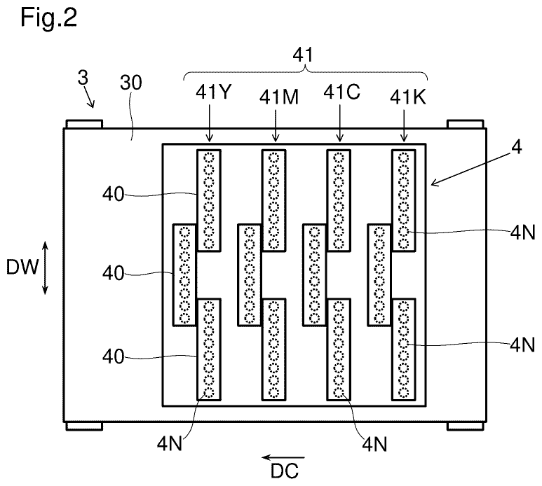

The recording part 4, as shown in FIG. 2, includes four line heads 41 corresponding to individual colors of cyan, magenta, yellow and black, respectively. In FIG. 2, sign ‘C’ is suffixed to the cyan line head 41, sign ‘M’ is suffixed to the magenta line head 41, sign ‘Y’ is suffixed to the yellow line head 41, and sign ‘K’ is suffixed to the black line head 41, for distinction sake.

The line head 41 of each color includes a plurality (e.g., three) of recording heads 40. For example, the plural recording heads 40 of each color are arrayed in a staggered arrangement in a direction perpendicular to the conveyance direction of the sheet S by the conveyor belt 30. Hereinafter, the direction perpendicular to the conveyance direction of the sheet S by the conveyor belt 30 may be referred to simply as belt widthwise direction. In the figures for reference in the following description, a direction indicated by sign DW is the belt widthwise direction.

The recording heads 40 are placed so as to be separated by a spacing in the up/down direction from the outer circumferential surface of the conveyor belt 30. In other words, the recording heads 40 are placed at positions, respectively, opposed in the up/down direction to the sheet S being conveyed by the conveyor belt 30. In still other words, the conveyor belt 30 sucks up and conveys the sheet S under the recording heads 40.

Each recording head 40 has, as a nozzle surface, a surface opposed in the up/down direction to the outer circumferential surface of the conveyor belt 30. The nozzle surface of each recording head 40 has a plurality of nozzles 4N. The plurality of nozzles 4N in each recording head 40 eject ink of a corresponding color downward. Each recording head 40 has an equal number of nozzles 4N, as an example. The plurality of nozzles 4N in each recording head 40 are arrayed along the belt widthwise direction. In FIG. 2, the nozzles 4N are depicted by broken line. In addition, actually, greater numbers of nozzles 4N are provided in each recording head 40. For convenience' sake, signs are added only to part of the nozzles 4N.

Based on image data to be printed on the sheet S in a print job, each recording head 40 ejects ink from the nozzles 4N toward the sheet S laid on the outer circumferential surface of the conveyor belt 30. The ink ejected from each recording head 40 adheres to the sheet S. As a result, an image is printed on the sheet S. In other words, with a print position defined between each recording head 40 and the conveyor belt 30, printing of the image onto the sheet S is executed at the print position.

In this connection, ink remaining at nozzles 4N that have undergone less ink ejections out of the plurality of nozzles 4N increases in viscosity more and more with time elapses. Due to this, cloggings occur, and image quality deteriorates. With an aim of suppressing such disadvantages, the individual recording heads 40 are subjected to flushing process. In the flushing process with the recording heads 40, ink remaining at the nozzles 4N is ejected. Thus, cloggings are suppressed. The flushing process will be detailed later.

Reverting to FIG. 1, the printer 100 includes a drying unit 51 and a decurler 52. The drying unit 51, while conveying the sheet S toward the decurler 52, dries ink adhering to the sheet S being under conveyance. The decurler 52 corrects curls of the sheet S. The decurler 52 conveys the curl-corrected sheet S toward the second conveyance part 2.

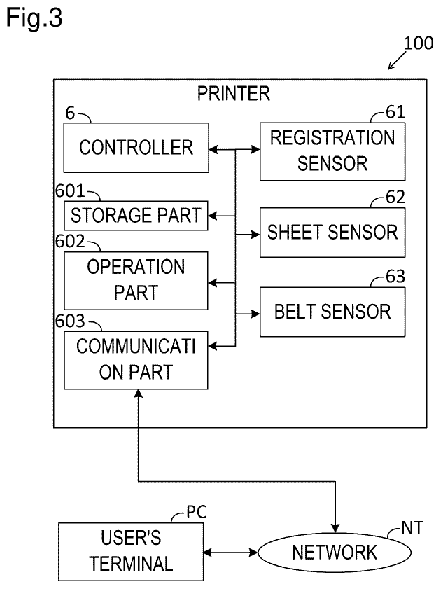

As shown in FIG. 3, the printer 100 also includes a controller 6. The controller 6 includes a CPU and ASIC or other processing circuits. The controller 6 controls print jobs. In other words, the controller 6 controls operations of the first conveyance part 1, the second conveyance part 2, the belt conveyance part 3, the recording part 4, the drying unit 51 and the decurler 52. In still other words, the controller 6 controls conveyance of the sheet as well as ink ejection of the recording heads 40. The controller 6 also controls the flushing process by the recording heads 40.

A registration sensor 61, a sheet sensor 62 and a belt sensor 63 are connected to the controller 6. Based on individual outputs of the registration sensor 61, the sheet sensor 62 and the belt sensor 63, the controller 6 controls conveyance of the sheet S and image recording onto the sheet S.

The registration sensor 61 has a detection position located upstream of the registration nip in the sheet S conveyance direction. The registration sensor 61 is exemplified by a reflection or transmission type optical sensor. The registration sensor 61 is variable in its output value in response to presence or absence of the sheet S at a corresponding detection position.

Based on an output value of the registration sensor 61, the controller 6 detects a front-end arrival and a rear-end passage of the sheet S at the detection position of the registration sensor 61. In other words, based on an output value of the registration sensor 61, the controller 6 detects a front-end arrival and a rear-end passage of the sheet S at the registration nip. The controller 6, on a basis of elapsed time since detection of a front-end arrival of the sheet S at the detection position of the registration sensor 61, measures a conveyance-start timing of the sheet S by the registration roller pair 11 (rotation-start timing of the registration roller pair 11).

The sheet sensor 62 has a detection position located between the registration nip and a recording position of a line head 41 placed on the most upstream side in the sheet S conveyance direction out of the plural line heads 41. The sheet sensor 62 yields an output value variable in response to presence or absence of the sheet S at a corresponding detection position. The sheet sensor 62 may be given by a CIS (Contact Image Sensor) or by a reflection or transmission type optical sensor. As an example, a CIS is used as the sheet sensor 62.

Based on an output value of the sheet sensor 62, the controller 6 detects a front-end arrival and a rear-end passage of the sheet S at the detection position of the sheet sensor 62. Based on an output value of the sheet sensor 62, the controller 6 measures an ink ejection timing to the sheet S conveyed by the conveyor belt 30. In addition, the ink ejection timing to the sheet S conveyed by the conveyor belt 30 may also be measured based on elapsed time since a conveyance start of the sheet S by the registration roller pair 11.

The controller 6 also measures sheet passage time elapsed since a front-end arrival of the sheet S at the detection position of the sheet sensor 62 until a rear-end passage of the same sheet S through the detection position of the sheet sensor 62. The sheet passage time at the detection position of the sheet sensor 62 is variable in response to a size (more specifically, conveyance-direction size) of the sheet S. Therefore, based on the sheet passage time, the controller 6 recognizes the size of the sheet S conveyed by the conveyor belt 30. As a result, the controller 6 is enabled to recognize the size of the sheet S even though the sheet S conveyed by the conveyor belt 30 is irregular-sized.

The belt sensor 63 is a sensor for detecting a predetermined reference position (home position) of the conveyor belt 30. A specified mark, as an example, is provided at the reference position of the conveyor belt 30. This allows the reference position of the conveyor belt 30 to be detected based on an output value of the belt sensor 63. A CIS may be used as the belt sensor 63. Also, a transmission or reflection type optical sensor may be used as the belt sensor 63.

Based on an output value of the belt sensor 63, the controller 6 detects the reference position of the conveyor belt 30. In other words, based on an output value of the belt sensor 63, the controller 6 detects a position of a later-described flushing zone 31 (flushing holes 30a).

The printer 100 further includes a storage part 601. The storage part 601 includes ROM, RAM or other memory devices. The storage part 601 is connected to the controller 6. The controller 6 performs readout of information from the storage part 601. The controller 6 also performs write of information into the storage part 601.

The printer 100 includes an operation part 602. The operation part 602 includes a touch screen as an example. The touch screen displays software buttons, massages and the like to accept touch operations from a user. Also provided in the operation part are hardware buttons for accepting settings, instructions and the like. The operation part 602 is connected to the controller 6. The controller 6 controls display operations of the operation part 602 (touch screen). The controller 6 also detects operations performed on the operation part 602.

The printer 100 further includes a communication part 603. The communication part 603 includes a communication circuit or the like. The communication part 603 is connected to users' terminal PCs via a network NT. A user's terminal PC is an information processing device such as a personal computer. The controller 6 communicates with the user's terminal PC by using the communication part 603. For example, print data (PDL data etc.) including image data to be recorded on the sheet S in a print job are transmitted from the user's terminal PC to the printer 100. In other words, an execution request for a print job is transmitted from the user's terminal PC to the printer 100. The print data of the print job includes various setting data related to printing such as a size of the sheet S to be used for the print job.

### Outline of Flushing Process

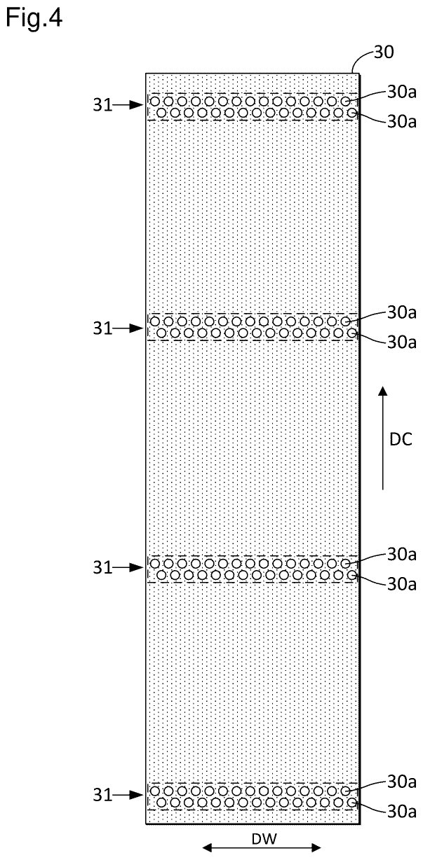

As shown in FIG. 4, the conveyor belt 30 has flushing zones 31. Each of the flushing zones 31 is surrounded by broken line in FIG. 4. A flushing zone 31 is an area including flushing holes 30a that are through holes extending through the conveyor belt 30 in its thicknesswise direction. A plurality of flushing zones 31 are provided in the conveyor belt 30. The plurality of flushing zones 31 are placed with specified intervals to one another in a rotational direction of the conveyor belt 30 (conveyance direction of the sheet S).

Each flushing zone 31 includes a plurality of flushing holes 30a. An opening shape (a shape as viewed in the thicknesswise direction of the conveyor belt 30) of each flushing hole 30a is not particularly limited. The shape of each flushing hole 30a may be any one of a circular shape, an elliptical shape, an oval shape and a rectangular shape. As the conveyor belt 30 is rotated around, the plurality of nozzles 4N are each opposed to at least any one of the flushing holes 30a in the up/down direction.

As the flushing process, a process of ejecting ink from the nozzles 4N of the individual recording heads 40 is executed. During execution of the flushing process, ink is ejected from the nozzles 4N at timings of opposition to the flushing holes 30a in the up/down direction. Then, ink is allowed to pass through the flushing holes 30a. As a result of this, even with the flushing process executed, ink is kept from adhering to the conveyor belt 30. Hereinafter, ink ejected from the nozzles 4N during the execution of the flushing process will be referred to as flushing ink so as to be distinguished from ink that contributes to image recording onto the sheet S. The flushing ink is ink that does not contribute to printing (recording) of images onto the sheet S.

In the course of a print job, the controller 6 controls the flushing process. More specifically, the controller 6 measures a conveyance-start timing of the sheet S from the registration roller pair 11 to the conveyor belt 30 in such fashion that flushing zones 31 appear at a constant periodicity in sheet-to-sheet intervals (intervals between a rear end of a preceding sheet S and a front end of a succeeding sheet S). Then, at timings when the nozzles 4N are opposed in the up/down direction to flushing holes 30a non-overlapping with the sheet S, the controller 6 makes ink ejected from the nozzles 4N. In other words, the controller 6 makes ink ejected from the nozzles 4N at timings other than image printing timings (image recording timings) onto the sheet S.

### Storage of Flushing Ink

The flushing ink is stored in a main body of the printer 100 (hereinafter, referred to as apparatus body). Then, when storage quantity of the flushing ink has reached a specified quantity, the flushing ink is put to disposal.

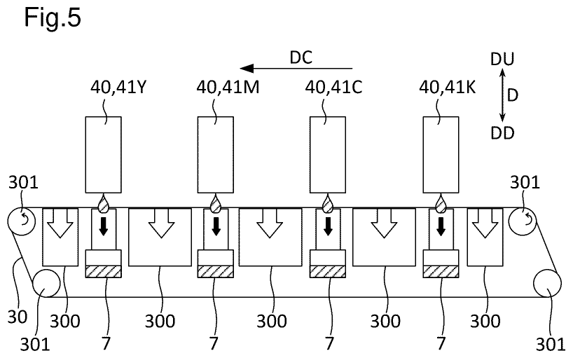

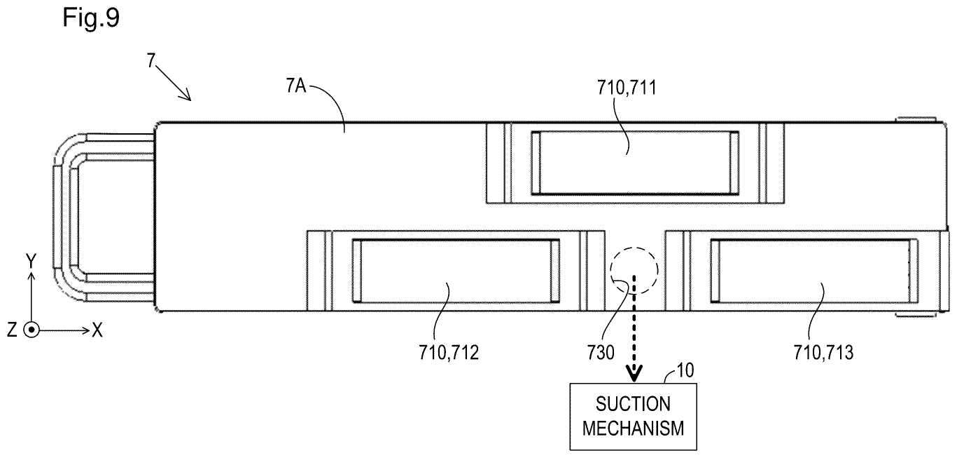

More specifically, as shown in FIGS. 5 to 7, the printer 100 includes waste ink containers 7 for storing flushing ink. The printer 100 also includes a suction mechanism 10 (see FIG. 9) to be connected to each waste ink container 7. The suction mechanism 10 sucks up gas from the waste ink container 7.

In the flushing process, the flushing ink, while passing through the flushing holes 30a of the conveyor belt 30, is sucked by a function of the suction mechanism 10 so as to reach the waste ink containers 7. Each waste ink container 7 has a storage area inside. The waste ink container 7 stores flushing ink in the storage area. It is noted that mist of the flushing ink becomes less likely to come out of the waste ink containers 7 by suction of the suction mechanism 10.

The waste ink container 7 is provided in plurality. Waste ink containers 7 are provided in one-to-one assignment with the line heads 41. In other words, waste ink containers 7 are provided in one-to-one assignment with the colors of cyan, magenta, yellow and black.

Each waste ink container 7 is set on an inner circumferential side of the conveyor belt 30 within the apparatus body. The individual waste ink containers 7, when set to the apparatus body, are placed under the recording heads 40 that eject ink of corresponding colors, respectively. Each waste ink container 7 is placed in opposition to the nozzle surfaces of corresponding recording heads 40, respectively, with the conveyor belt 30 interposed therebetween. That is, each waste ink container 7 is placed so as to be opposed to its corresponding recording heads 40 in the up/down direction with the sheet S conveyance path positioned therebetween. Thus, during execution of the flushing process, the flushing ink passes through the flushing holes 30a, being stored in the storage areas of the waste ink containers 7.

Each waste ink container 7 is removably set to the apparatus body. The waste ink container 7 can be removed from the apparatus body by being drawn out from the apparatus front of the printer 100 toward the user. When the storage quantity of flushing ink in any one of the waste ink containers 7 has reached a specified quantity, the relevant waste ink container 7 is removed from the apparatus body and replaced with another.

The suction mechanism 10 causes suction airflow to arise. Suction mechanisms 10 are provided in one-to-one assignment with the waste ink containers 7. The suction mechanism 10 is connected to the corresponding waste ink container 7 to suck flushing ink from the corresponding recording heads 40 toward the storage area of the waste ink container 7. By flushing ink being sucked by the function of each suction mechanism 10, internal contamination of the apparatus due to the flushing ink can be suppressed. In FIG. 5, sucking directions of the flushing ink are indicated by black-solid arrows. White-hollow arrows indicate sucking directions by the suction units 300.

The individual waste ink containers 7 store ink destined for disposal such as flushing ink. The ink destined for disposal is ink that is ejected from the recording heads 40 but not used for printing (image recording). That is, the waste ink containers 7 store ink that does not contribute to printing. Hereinafter, for convenience' sake, ink destined for disposal including flushing ink will be referred to generically as flushing ink.

### Configuration of Waste Ink Container

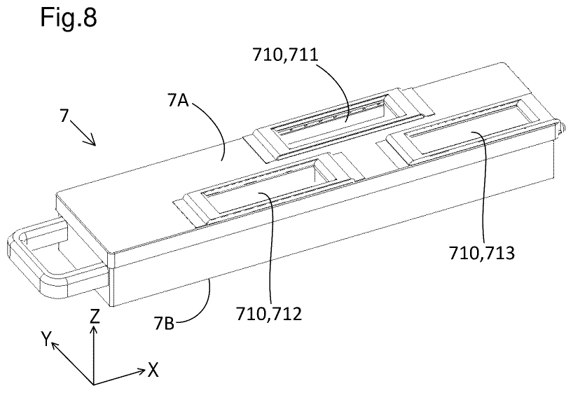

Hereinafter, with reference to FIGS. 8 to 21, a configuration of the waste ink containers 7 will be described by focusing on one waste ink container 7. The waste ink containers 7 are identical in configuration to one another. Therefore, description of the configuration of the other waste ink containers 7 is omitted by referencing the following description.

Hereinafter, an XYZ orthogonal coordinate system is used for easier understanding. An X direction along an X axis is one of horizontal directions, being equivalent to a front/rear direction of the waste ink container 7. A Y direction along a Y axis is a direction other than the horizontal directions, being equivalent to a left/right direction of the waste ink container 7. A Z direction along a Z axis is a vertical direction, being equivalent to an up/down direction of the waste ink container 7.

Also hereinafter, the X direction is designated as front/rear direction, the Y direction is designated as left/right direction, and the Z direction is designated as up/down direction. In addition, an arrow of the X axis is oriented rearward, its opposite side being forward. An arrow of the Y axis is oriented leftward, its opposite side being rightward. An arrow of the Z axis is oriented upward, its opposite side being downward.

Furthermore, the left/right direction (Y direction) corresponds to a ‘first direction’. Also, the up/down direction (Z direction) corresponds to a ‘second direction’. A sheet S under conveyance by the conveyor belt 30 travels toward one side of the Y direction. A waste ink container 7 is placed so as to be opposed to the recording head 40 in the Z direction with the conveyance path of the sheet S positioned therebetween.

The waste ink container 7 is a generally rectangular parallelepiped-shaped container. The waste ink container 7 has a storage area which, as viewed in the up/down direction, is longer in the front/rear direction and shorter in the left/right direction. More specifically, the waste ink container 7 has a ceiling portion 7A as well as a bottom portion 7B opposed to the ceiling portion 7A in the up/down direction. The waste ink container 7 also has side wall portions (sign omitted) surrounding an area between the ceiling portion 7A and the bottom portion 7B in the front/rear and left/right directions. Then, the area surrounded by the ceiling portion 7A, the bottom portion 7B and the side wall portions serves as the storage area.

The ceiling portion 7A, the bottom portion 7B and the side wall portions are formed from a gas-impermeable material. The ceiling portion 7A, the bottom portion 7B and the side wall portions are formed from a material which is generally impermeable to misty flushing ink (i.e., a gas containing flushing ink). The ceiling portion 7A, the bottom portion 7B and the side wall portions are lower in gas permeability at least than a later-described absorption member 8. The ceiling portion 7A, the bottom portion 7B and the side wall portions may be formed from metal or resin.

The ceiling portion 7A functions as an ink receiver for receiving flushing ink sucked by the suction mechanism 10. In more detail, the ceiling portion 7A has a reception hole 710 extending in the up/down direction as it is rectangular-shaped. The reception hole 710 is provided in plurality. Also, the reception hole 710 is opened upward. That is, the reception hole 710 is opened in the up/down direction.

Reception holes 710 are provided in one-to-one assignment with the recording heads 40. In a case where three recording heads 40 are provided, the reception holes 710 count three. Each reception hole 710 is opposed in the up/down direction to the corresponding recording head 40 with the conveyor belt 30 (i.e., sheet S conveyance direction) positioned therebetween. Therefore, the reception holes 710 are placed with a spacing from one another as viewed in the up/down direction.

Each reception hole 710 is an opening for collecting flushing ink, which is ejected from the corresponding recording head 40, into the storage area of the waste ink container 7. The flushing ink in the recording head 40, passing through the corresponding reception hole 710, reaches the storage area of the waste ink container 7.

Out of the three reception holes 710, one reception hole 710 is placed with a spacing in the left/right direction from a later-described suction hole 730 as viewed in the up/down direction. In more detail, the one reception hole 710 is placed on a left side of the suction hole 730 as viewed in the up/down direction. Hereinafter, one reception hole 710 like this will be referred to as central reception hole 711. An opening shape of the central reception hole 711 as viewed in the up/down direction is generally rectangular shaped with its longitudinal direction being along the front/rear direction.

Also out of the three reception holes 710, two reception holes 710 other than the central reception hole 711 are placed with a spacing from each other provided in the front/rear direction, and with a later-described suction hole 730 interposed therebetween as viewed in the up/down direction. Out of the two reception holes 710, one is placed forward of the suction hole 730 while the other is placed rearward of the suction hole 730. Hereinafter, out of the two reception holes 710, one will be referred to as front-side reception hole 712 while the other will be referred to as rear-side reception hole 713. The front-side reception hole 712 and the rear-side reception hole 713 each have an opening shape, as viewed in the up/down direction, which is a generally rectangular shape with its longitudinal direction being along the front/rear direction.

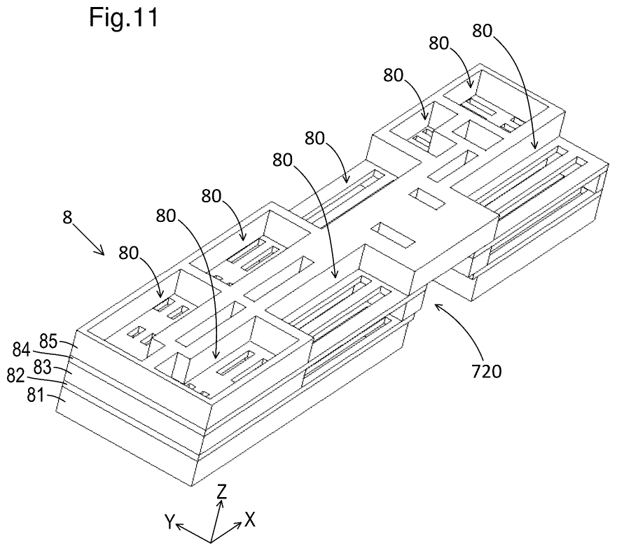

In this case, the waste ink container 7 has an absorption member 8 as shown in FIG. 11. The absorption member 8 is placed in the storage area of the waste ink container 7. The absorption member 8 is a porous member that absorbs flushing ink. Melamine sponge may be used as a constituent material of the absorption member 8. The absorption member 8 absorbs flushing ink and holds the flushing ink inside.

The waste ink container 7 has, in its storage area, suction airflow paths 70 defined by the absorption member 8. The suction airflow paths 70 are formed by spaces having no presence of the absorption member 8 out of the storage area of the waste ink container 7 (i.e., clearances present in the storage area). The suction airflow paths 70 are spaces obtained by partly cutting away the absorption member 8. The suction airflow paths 70 are spaces each surrounded by the absorption member 8. The absorption member 8 serves as partitions that define the suction airflow paths 70. The suction airflow paths 70 allow a suction airflow generated by drive of the suction mechanism 10 to pass therethrough.

The suction airflow paths 70 are connected to the reception holes 710, respectively. That is, the suction airflow paths 70 are provided in plurality. Hereinafter, a suction airflow path 70 connected to the central reception hole 711 may be denoted by sign 71, a suction airflow path 70 connected to the front-side reception hole 712 may be denoted by sign 72, and a suction airflow path 70 connected to the rear-side reception hole 713 may be denoted by sign 73, as appropriate for distinction from one another.

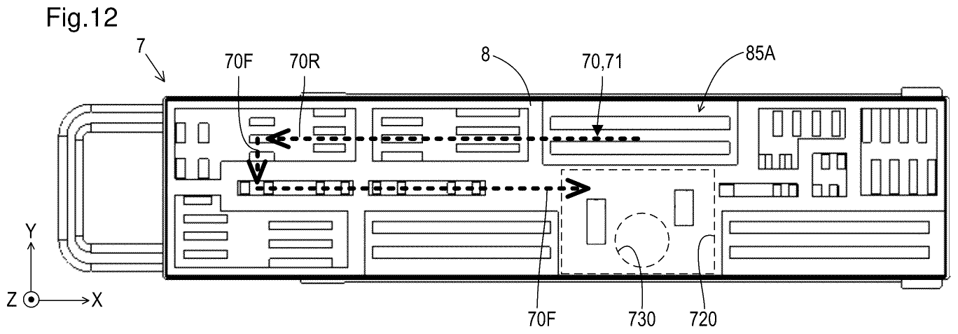

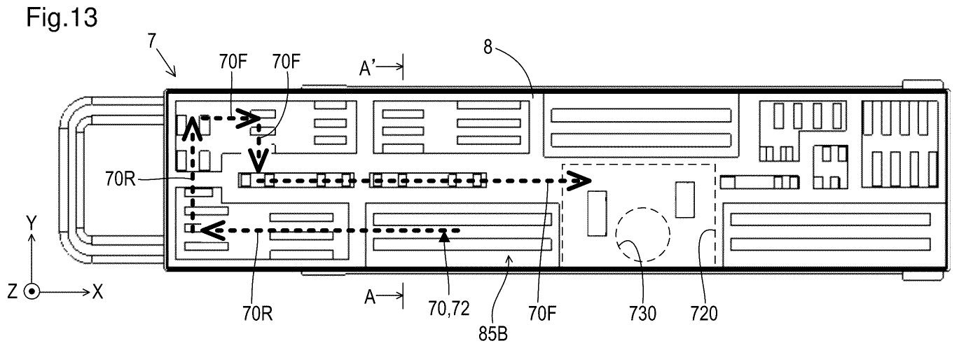

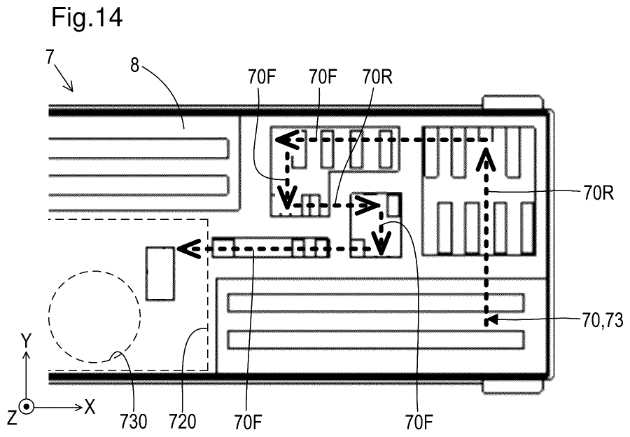

In addition, the suction airflow path 71 is shown in FIG. 12, the suction airflow path 72 is shown in FIG. 13, and the suction airflow path 73 is shown in FIG. 14. In these figures, a suction airflow path 70 is depicted schematically by broken-line arrow (bold line). A direction in which the broken-line arrow is directed corresponds to a direction in which the suction airflow flows as viewed in the up/down direction.

The waste ink container 7 has, in the storage area, a merging chamber 720 defined by the absorption member 8. The merging chamber 720 is placed at a position separated by spacings from individual plural reception holes 710, respectively, as viewed in the up/down direction. The merging chamber 720 is formed by a space having no presence of the absorption member 8 out of the storage area of the waste ink container 7, like the suction airflow paths 70. The merging chamber 720 is part of the suction airflow paths 70.

The waste ink container 7 has the suction hole 730 at a position overlapping with the merging chamber 720 as viewed in the up/down direction. That is, the suction hole 730 is placed at a position separate by spacings from individual plural reception holes 710, as viewed in the up/down direction.

The suction hole 730 extends through the bottom portion 7B in the up/down direction. The plurality of suction airflow paths 70 are connected to the suction hole 730. The plural suction airflow paths 70 allow each of the plural reception holes 710 to be communicated with the suction hole 730. The suction hole 730 allows the merging chamber 720 to be communicated with outside of the storage area. The suction hole 730 is also connected to the suction mechanism 10.

The suction mechanism 10 is placed outside the waste ink container 7, and connected to the suction hole 730 via an unshown duct. As the suction mechanism 10 is driven, there arise suction airflows flowing from the individual reception holes 710 toward the merging chamber 720 (i.e., the suction hole 730).

A suction airflow contains mist of flushing ink. When misty flushing ink leaks out via the suction hole 730, there occur disadvantages such as contamination of the printer 100 interior. In order to suppress occurrence of such disadvantages, there is a need for successfully separating a gas flowing along the suction airflow paths 70 (i.e., a gas sucked by the suction mechanism 10) and flushing ink from each other in the storage area of the waste ink container 7 so as to let the absorption member 8 absorb the flushing ink. That is, there is a need for enhancing collection efficiency of flushing ink in the storage area of the waste ink container 7.

With an aim of enhancing the collection efficiency of flushing ink in the storage area of the waste ink container 7, inner walls of the suction airflow paths 70 are formed from the absorption member 8. With this formation, flushing ink is absorbed into the absorption member 8, so that the collection efficiency of flushing ink is enhanced. The more the bends of the suction airflow paths 70 are included, the more the flushing ink contained in the gas flowing along the suction airflow paths 70 is separated by centrifugal force, and the more the collection efficiency of the flushing ink is enhanced.

The absorption member 8 is made up of five layers including a first absorption layer 81, a second absorption layer 82, a third absorption layer 83, a fourth absorption layer 84 and a fifth absorption layer 85 (see FIG. 11). The first to fifth absorption layers 81 to 85 are stacked in this order from below to above. The first to fifth absorption layers 81 to 85 are formed all from a porous member capable of absorbing flushing ink.

Each of the first to fifth absorption layers 81 to 85 has at least one opening 80 extending therethrough in the up/down direction. In FIG. 11, reference signs are added only to some of the openings 80 for convenience' sake. In the storage area of the waste ink container 7, the first to fifth absorption layers 81 to 85 are stacked one after another in such fashion that openings 80 mutually adjoining in the up/down direction are communicated with each other so as to form spaces extending from the reception holes 710 to the suction hole 730. That is, the suction airflow paths 70 are formed by those spaces.

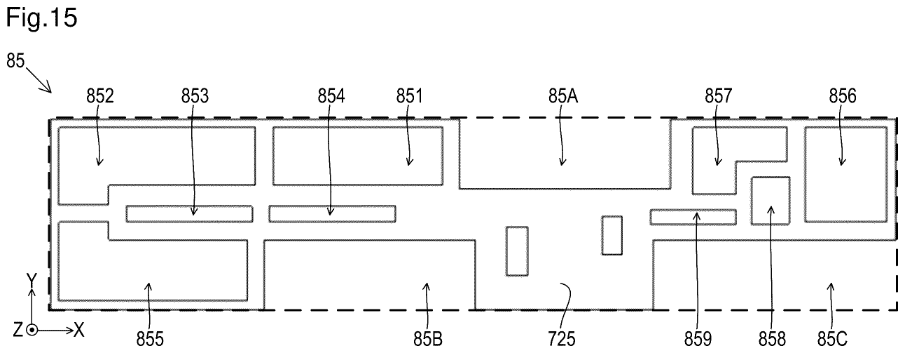

The fifth absorption layer 85 has such a planar shape as shown in FIG. 15. The fifth absorption layer 85 is placed uppermost within the storage area. In other words, the fifth absorption layer 85 is placed underneath the ceiling portion 7A. FIG. 15 shows the storage area by broken line (bold line) as viewed in the up/down direction.

The fifth absorption layer 85 has openings 85A, 85B and 85C as openings 80. The opening 85A overlaps with the central reception hole 711 in the up/down direction, and communicates with the central reception hole 711 in the up/down direction. The opening 85B overlaps with the front-side reception hole 712 in the up/down direction, and communicates with the front-side reception hole 712 in the up/down direction. The opening 85C overlaps with the rear-side reception hole 713 in the up/down direction, and communicates with the rear-side reception hole 713 in the up/down direction.

Also, the fifth absorption layer 85 has openings 851, 852, 853, 854, 855, 856, 857, 858 and 859 as openings 80.

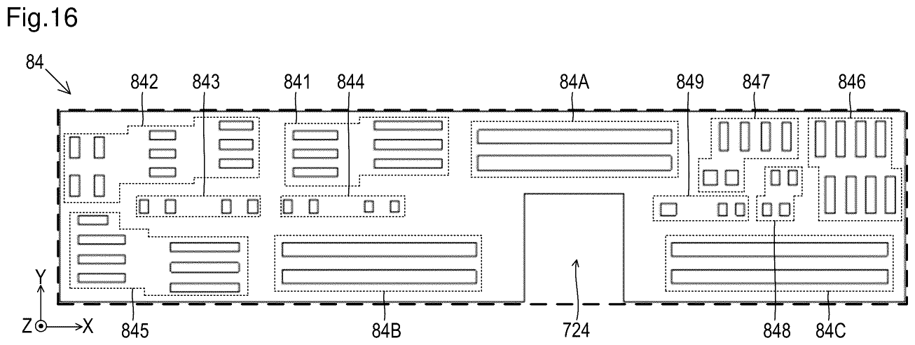

The fourth absorption layer 84 has such a planar shape as shown in FIG. 16. The fourth absorption layer 84 is placed underneath the fifth absorption layer 85 so as to overlap with the fifth absorption layer 85 in the up/down direction. The fourth absorption layer 84 is one-layer lower than the fifth absorption layer 85. FIG. 16 shows the storage area by broken line (bold line) as viewed in the up/down direction.

The fourth absorption layer 84 has openings 84A, 84B and 84C as openings 80. The opening 84A overlaps with the opening 85A in the up/down direction, and communicates with the opening 85A in the up/down direction. The opening 84B overlaps with the opening 85B in the up/down direction, and communicates with the opening 85B in the up/down direction. The opening 84C overlaps with the opening 85C in the up/down direction, and communicates with the opening 85C in the up/down direction. The openings 84A, 84B and 84C are provided each in plurality. In FIG. 16, for convenience' sake, the openings 84A, 84B and 84C are each surrounded by broken line, with lead-out lines added to those areas surrounded by broken line.

Also, the fourth absorption layer 84 has openings 841, 842, 843, 844, 845, 846, 847, 848 and 849 as openings 80. The openings 841, 842, 843, 844, 845, 846, 847, 848 and 849 are provided each in plurality. In FIG. 16, for convenience' sake, the openings 841, 842, 843, 844, 845, 846, 847, 848 and 849 are each surrounded by broken line, with lead-out lines added to those areas surrounded by broken line.

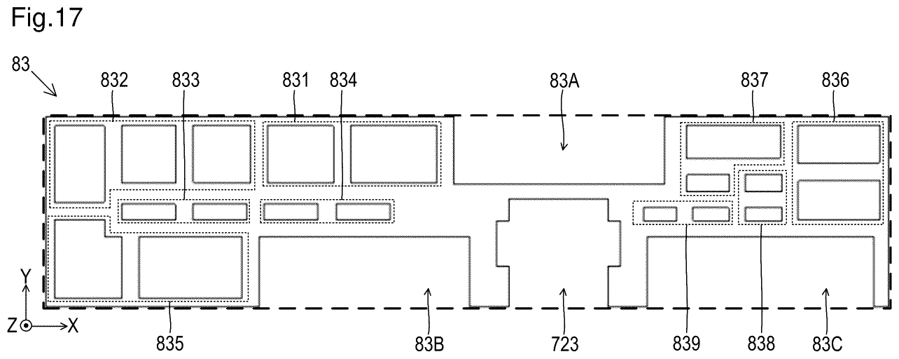

The third absorption layer 83 has such a planar shape as shown in FIG. 17. The third absorption layer 83 is placed under the fourth absorption layer 84 so as to overlap with the fourth absorption layer 84 in the up/down direction. The third absorption layer 83 is one-layer lower than the fourth absorption layer 84. FIG. 17 shows the storage area by broken line (bold line) as viewed in the up/down direction.

The third absorption layer 83 has openings 83A, 83B and 83C as openings 80. The opening 83A overlaps with the opening 84A in the up/down direction, and communicates with the opening 84A in the up/down direction. The opening 83B overlaps with the opening 84B in the up/down direction, and communicates with the opening 84B in the up/down direction. The opening 83C overlaps with the opening 84C in the up/down direction, and communicates with the opening 84C in the up/down direction.

Also, the third absorption layer 83 has openings 831, 832, 833, 834, 835, 836, 837, 838 and 839 as openings 80. The openings 831, 832, 833, 834, 835, 836, 837, 838 and 839 are provided each in plurality. In FIG. 17, for convenience' sake, the openings 831, 832, 833, 834, 835, 836, 837, 838 and 839 are each surrounded by broken line, with lead-out lines added to those areas surrounded by broken line.

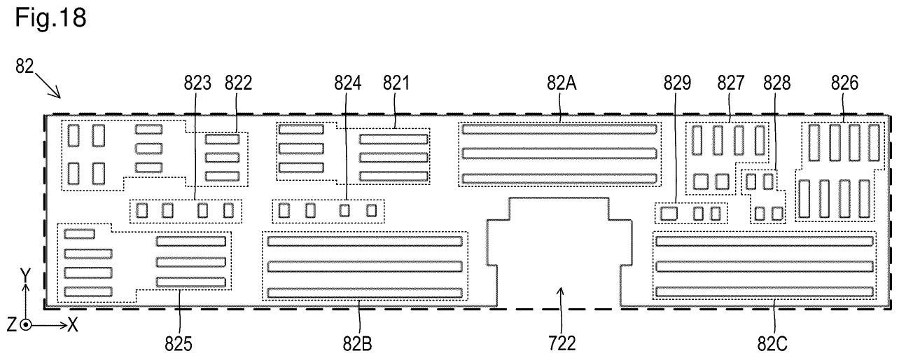

The second absorption layer 82 has such a planar shape as shown in FIG. 18. The second absorption layer 82 is placed under the third absorption layer 83 so as to overlap with the third absorption layer 83 in the up/down direction. The second absorption layer 82 is one-layer lower than the third absorption layer 83.

The second absorption layer 82 has openings 82A, 82B and 82C as openings 80. The opening 82A overlaps with the opening 83A in the up/down direction, and communicates with the opening 83A in the up/down direction. The opening 82B overlaps with the opening 83B in the up/down direction, and communicates with the opening 83B in the up/down direction. The opening 82C overlaps with the opening 83C in the up/down direction, and communicates with the opening 83C in the up/down direction. The openings 82A, 82B and 82C are provided each in plurality. In FIG. 18, for convenience' sake, the openings 82A, 82B and 82C are each surrounded by broken line, with lead-out lines added to those areas surrounded by broken line.

Also, the second absorption layer 82 has openings 821, 822, 823, 824, 825, 826, 827, 828 and 829 as openings 80. The openings 821, 822, 823, 824, 825, 826, 827, 828 and 829 are provided each in plurality. In FIG. 18, for convenience' sake, the openings 821, 822, 823, 824, 825, 826, 827, 828 and 829 are each surrounded by broken line, with lead-out lines added to those areas surrounded by broken line.

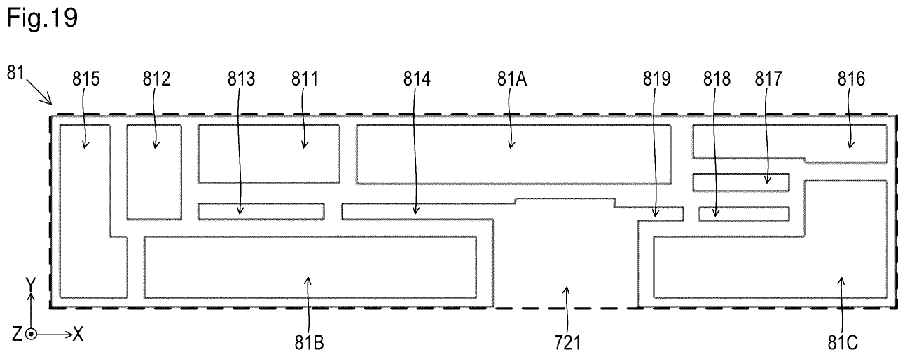

The first absorption layer 81 has such a planar shape as shown in FIG. 19. The first absorption layer 81 is placed under the second absorption layer 82 so as to overlap with the second absorption layer 82 in the up/down direction. The first absorption layer 81 is one-layer lower than the second absorption layer 82. The first absorption layer 81 is placed lowest within the storage area. In other words, the first absorption layer 81 is placed directly above the bottom portion 7B.

The first absorption layer 81 has openings 81A, 81B and 81C as openings 80. The opening 81A overlaps with the opening 82A in the up/down direction, and communicates with the opening 82A in the up/down direction. The opening 81B overlaps with the opening 82B in the up/down direction, and communicates with the opening 82B in the up/down direction. The opening 81C overlaps with the opening 82C in the up/down direction, and communicates with the opening 82C in the up/down direction.

Also, the first absorption layer 81 has openings 811, 812, 813, 814, 815, 816, 817, 818 and 819 as openings 80.

In addition, the fifth absorption layer 85 has a portion 725 (see FIG. 15) that covers the merging chamber 720 from above. The fourth absorption layer 84 has an opening 724 (see FIG. 16) serving as the merging chamber 720. The third absorption layer 83 has an opening 723 (see FIG. 17) serving as the merging chamber 720. The second absorption layer 82 has an opening 722 (see FIG. 18) serving as the merging chamber 720. The first absorption layer 81 has an opening 721 (see FIG. 19) serving as the merging chamber 720.

Then, as shown in FIG. 19, the opening 721 communicates with the opening 814 and moreover communicates with the opening 819. In other words, the merging chamber 720 communicates with the opening 814, and moreover communicates with the opening 819. In still other words, the openings 814 and 819 each communicate with the suction hole 730.

The suction airflow paths 70 are composed of the individual openings of the first to fifth absorption layers 81 to 85. By suction airflows flowing along the suction airflow paths 70, as shown in FIGS. 12 to 14, suction airflows flow in directions indicated by broken-line arrows (bold lines) as viewed in the up/down direction. Flowing paths of suction airflows from the reception holes 710 to the suction hole 730 will be described in detail below.

1. Flow Paths of Suction Airflows from Central Reception Hole 711 to Suction Hole 730

A suction airflow derived from the central reception hole 711 flows through the openings 85A, 84A, 83A and 82A in this order. Then, the suction airflow reaches the opening 81A.

The opening 81A communicates with the opening 851 via the openings 821, 831 and 841. Also, the opening 851 communicates with the opening 811 via the openings 841, 831 and 821. With this arrangement, the suction airflow flows from the opening 81A through the openings 821, 831 and 841 in this order to reach the opening 851. Also, the suction airflow reaches the opening 811 from the opening 851 via the openings 841, 831 and 821.

The opening 811 communicates with the opening 852 via the openings 822, 832 and 842. Also, the opening 852 communicates with the opening 812 via the openings 842, 832 and 822. With this arrangement, the suction airflow flows from the opening 811 through the openings 822, 832 and 842 in this order to reach the opening 852. Also, the suction airflow reaches the opening 812 from the opening 852 via the openings 842, 832 and 822.

The opening 812 communicates with the opening 853 via the openings 823, 833 and 843. Also, the opening 853 communicates with the opening 813 via the openings 843, 833 and 823. With this arrangement, the suction airflow flows from the opening 812 through the openings 823, 833 and 843 in this order to reach the opening 853. Also, the suction airflow reaches the opening 813 from the opening 853 via the openings 843, 833 and 823.

The opening 813 communicates with the opening 854 via the openings 824, 834 and 844. Also, the opening 854 communicates with the opening 814 via the openings 844, 834 and 824. With this arrangement, the suction airflow flows from the opening 813 through the openings 824, 834 and 844 in this order to reach the opening 854. Also, the suction airflow flows from the opening 854 via the openings 844, 834 and 824 in this order to reach the opening 814.

The opening 814 communicates with the opening 721 forming a portion of the merging chamber 720. That is, the opening 814 communicates with the suction hole 730. As a result, the suction airflow reaches the suction hole 730 from the central reception hole 711.

2. Flow Paths of Suction Airflow from Front-Side Reception Hole 712 to Suction Hole 730

A suction airflow derived from the front-side reception hole 712 flows through the openings 85B, 84B, 83B and 82B in this order. Then, the suction airflow reaches the opening 81B.

The opening 81B communicates with the opening 855 via the openings 825, 835 and 845. Also, the opening 855 communicates with the opening 815 via the openings 843, 833 and 823. With this arrangement, the suction airflow flows from the opening 81B through the openings 825, 835 and 845 in this order to reach the opening 855. Also, the suction airflow flows from the opening 855 via the openings 843, 833 and 823 to reach the opening 815.

The opening 815 communicates with the opening 852 via the openings 822, 832 and 842. Also, the opening 852 communicates with the opening 812 via the openings 842, 832 and 822. With this arrangement, the suction airflow flows from the opening 811 through the openings 822, 832 and 842 in this order to reach the opening 852. Also, the suction airflow flows from the opening 852 via the openings 842, 832 and 822 to reach the opening 812.

The opening 812 communicates with the opening 853 via the openings 823, 833 and 843. Also, the opening 853 communicates with the opening 813 via the openings 843, 833 and 823. With this arrangement, the suction airflow flows from the opening 812 through the openings 823, 833 and 843 in this order to reach the opening 853. Also, the suction airflow flows from the opening 853 via the openings 843, 833 and 823 to reach the opening 813.

The opening 813 communicates with the opening 854 via the openings 824, 834 and 844. Also, the opening 854 communicates with the opening 814 via the openings 844, 834 and 824. With this arrangement, the suction airflow flows from the opening 813 through the openings 824, 834 and 844 in this order to reach the opening 854. Also, the suction airflow flows from the opening 854 via the openings 844, 834 and 824 in this order to reach the opening 814.

The opening 814 communicates with the opening 721 forming a portion of the merging chamber 720. That is, the opening 814 communicates with the suction hole 730. As a result, the suction airflow reaches the suction hole 730 from the front-side reception hole 712.

3. Flow Paths of Suction Airflow from Rear-Side Reception Hole 713 to Suction Hole 730

A suction airflow derived from the rear-side reception hole 713 flows through the openings 85C, 84C, 83C and 82C in this order. Then, the suction airflow reaches the opening 81C.

The opening 81C communicates with the opening 856 via the openings 826, 836 and 846. Also, the opening 856 communicates with the opening 816 via the openings 846, 836 and 826. With this arrangement, the suction airflow flows from the opening 81C through the openings 826, 836 and 846 in this order to reach the opening 856. Also, the suction airflow flows from the opening 856 via the openings 846, 836 and 826 in this order to reach the opening 816.

The opening 816 communicates with the opening 857 via the openings 827, 837 and 847. Also, the opening 857 communicates with the opening 817 via the openings 847, 837 and 827. With this arrangement, the suction airflow flows from the opening 816 through the openings 827, 837 and 847 in this order to reach the opening 857. Also, the suction airflow flows from the opening 857 via the openings 847, 837 and 827 in this order to reach the opening 817.

The opening 817 communicates with the opening 858 via the openings 828, 838 and 848. Also, the opening 858 communicates with the opening 818 via the openings 848, 838 and 828. With this arrangement, the suction airflow flows from the opening 817 through the openings 828, 838 and 848 in this order to reach the opening 858. Also, the suction airflow reaches the opening 818 from the opening 858 via the openings 848, 838 and 828 in this order.

The opening 818 communicates with the opening 859 via the openings 829, 839 and 849. Also, the opening 859 communicates with the opening 819 via the openings 849, 839 and 829. With this arrangement, the suction airflow flows from the opening 818 through the openings 829, 839 and 849 in this order to reach the opening 859. Also, the suction airflow reaches the opening 819 from the opening 859 via the openings 849, 839 and 829 in this order.

The opening 819 communicates with the opening 721 forming a portion of the merging chamber 720. That is, the opening 819 communicates with the suction hole 730. As a result, the suction airflow reaches the suction hole 730 from the rear-side reception hole 713.

### Turbulent-Flow Generation Area

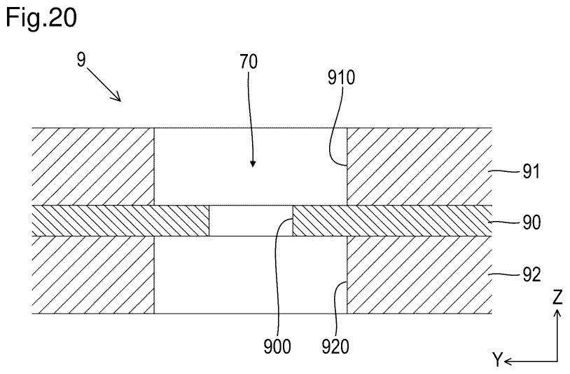

In this embodiment, a turbulent-flow generation area 9 (see FIG. 20) for generation of a turbulent flow is provided in the suction airflow paths 70. The turbulent-flow generation area 9 is an area for intentionally disturbing the suction airflow. A conceptual view of the turbulent-flow generation area 9 is shown in FIG. 20. FIG. 20 is equivalent to a cross-sectional view resulting from cutting the turbulent-flow generation area 9 and its vicinities by a plane (YZ plane) parallel to the up/down direction and the left/right direction. FIG. 20 schematically shows a cross-sectional structure of the turbulent-flow generation area 9 and its vicinities, not being a depiction with actual sizes, shapes and the like as they are.

The turbulent-flow generation area 9 is composed of openings 80 in up/down-succeeding three layers out of the first to fifth absorption layers 81 to 85 constituting the absorption member 8. Hereinafter, a layer of the three layers placed intermediate in the up/down direction will be referred to as an intermediate layer 90. Also, an up/down one-side (one side of upper and lower sides) layer relative to the intermediate layer 90 will be referred to as one-side layer 91, while the up/down other-side (other side of the upper and lower sides) layer relative to the intermediate layer 90 will be referred to as other-side layer 92. In this case, it can be said that the absorption member 8 includes the intermediate layer 90 as well as the one-side layer 91 and the other-side layer 92 between which the intermediate layer 90 is sandwiched in the up/down direction.

The one-side layer 91 has a one-side opening 910 extending through the one-side layer 91 in the up/down direction. The intermediate layer 90 has an intermediate opening 900 communicating with the one-side opening 910 in the up/down direction. The intermediate opening 900 extends through the intermediate layer 90 in the up/down direction. The other-side layer 92 has an other-side opening 920 communicating with the intermediate opening 900 in the up/down direction. The other-side opening 920 extends through the other-side layer 92 in the up/down direction.

A space defined by the one-side opening 910, the intermediate opening 900 and the other-side opening 920 forms a portion of the suction airflow path 70. A suction airflow within the storage area of the waste ink container 7 flows through the one-side opening 910, the intermediate opening 900 and the other-side opening 920 in this order. Otherwise, the suction airflow within the storage area of the waste ink container 7 flows through the other-side opening 920, the intermediate opening 900 and the one-side opening 910 in this order.

In this embodiment, the intermediate opening 900 is smaller in opening area than the one-side opening 910 and than the other-side opening 920. It is noted that the term ‘opening area’ refers to an area of the opening 80 as viewed in the up/down direction (i.e., magnitude of the opening 80 as viewed in the up/down direction).

As a result, in this embodiment, the suction airflow path 70 is constricted in a direction from the one-side opening 910 toward the intermediate opening 900 as well as in a direction from the other-side opening 920 toward the intermediate opening 900. In other words, the suction airflow path 70 is broadened in a direction from the intermediate opening 900 toward the one-side opening 910 as well as in a direction from the intermediate opening 900 toward the other-side opening 920. In still other words, as in a cross-sectional view resulting from cutting the absorption member 8 by a plane parallel to the up/down direction and the left/right direction, a width of the intermediate opening 900 in the left/right direction is smaller than a width of the one-side opening 910 in the left/right direction as well as smaller than a width of the other-side opening 920 in the left/right direction.

In this embodiment, by the turbulent-flow generation area 9 being provided in a suction airflow path 70, at a site of the suction airflow path 70 where the flow direction of the suction airflow comes to be directed from the one-side layer 91 via the intermediate layer 90 toward the other-side layer 92, the suction airflow directed from the one-side opening 910 toward the intermediate opening 900 collides with an outer edge portion of the intermediate opening 900. As a result of this, there occur disturbances to the suction airflow at an outer edge portion of the intermediate opening 900 on one side closer to the one-side layer 91 as well as its vicinities. Due to the occurrence of disturbances of the suction airflow at the outer edge portion of the intermediate opening 900 on one side closer to the one-side layer 91 as well as its vicinities, flushing ink contained in the gas flowing along the suction airflow path 70 is more likely to be absorbed to inner walls (i.e., absorption member 8) of the suction airflow path 70.

Further, at a site of the suction airflow path 70 where the flow direction of the suction airflow comes to be directed from the one-side layer 91 via the intermediate layer 90 toward the other-side layer 92, the suction airflow directed from the intermediate opening 900 toward the other-side opening 920 broadens in the horizontal direction along an outer edge portion of the intermediate opening 900 on one side closer to the other-side layer 92. As a result of this, there occur disturbances to the suction airflow at the outer edge portion of the intermediate opening 900 on one side closer to the other-side layer 92 as well as its vicinities. Due to the occurrence of disturbances of the suction airflow at the outer edge portion of the intermediate opening 900 on one side closer to the other-side layer 92 as well as its vicinities, flushing ink contained in the gas flowing along the suction airflow path 70 is more likely to be absorbed to inner walls (i.e., absorption member 8) of the suction airflow path 70.

By virtue of the above-described contrivances, in this embodiment, separation of flushing ink from the gas flowing along the suction airflow path 70 is successfully carried out. In other words, absorption quantity of flushing ink into the inner walls (i.e., absorption member 8) of the suction airflow path 70 increases, so that collection efficiency of flushing ink in the storage area of the waste ink container 7 is enhanced. As a result, leakage of flushing ink from the waste ink container 7 can be suppressed. Enabling suppression of leakage of the flushing ink from the waste ink container 7 makes it implementable to suppress occurrence of such disadvantages as in-apparatus (e.g., suction mechanism 10) contamination with flushing ink.

In addition, in this embodiment, it is allowable that the fifth absorption layer 85 serves as the one-side layer 91, the fourth absorption layer 84 serves as the intermediate layer 90, and the third absorption layer 83 serves as the other-side layer 92. In this case, any one opening 80 of the openings 80 in the fifth absorption layer 85 serves as the one-side opening 910, any one opening 80 of the openings 80 in the fourth absorption layer 84 serves as the intermediate opening 900, and any one opening 80 of the openings 80 in the third absorption layer 83 serves as the other-side opening 920.

Further, it is also allowable that the third absorption layer 83 serves as the one-side layer 91, the second absorption layer 82 serves as the intermediate layer 90, and the first absorption layer 81 serves as the other-side layer 92. In this case, the opening 80 of the third absorption layer 83 serves as the one-side opening 910, the opening 80 of the second absorption layer 82 serves as the intermediate opening 900, and the opening 80 of the first absorption layer 81 serves as the other-side opening 920.

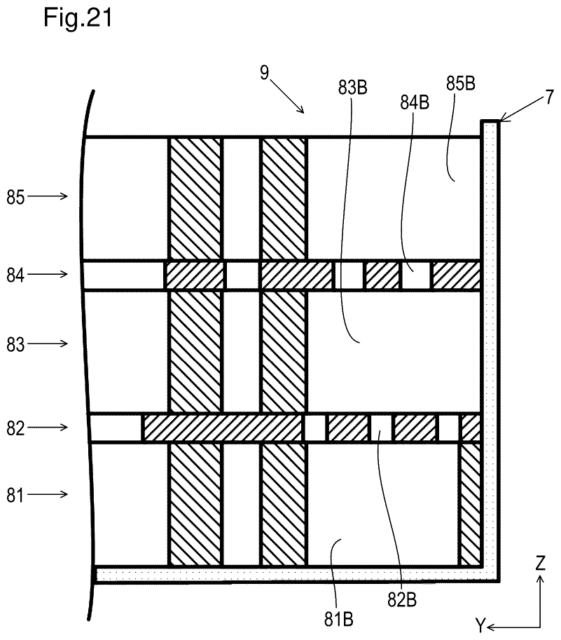

For instance, with regard to a site (see FIG. 21) of the suction airflow path 72 shown by a cross section along the line A-A′ of FIG. 13, the turbulent-flow generation area 9 (here is referred to as first turbulent-flow generation area 9) is composed of an opening 85B of the fifth absorption layer 85, an opening 84B of the fourth absorption layer 84, and an opening 83B of the third absorption layer 83. Also, a turbulent-flow generation area 9 (here is referred to as second turbulent-flow generation area 9) is composed of an opening 83B of the third absorption layer 83, an opening 82B of the second absorption layer 82, and an opening 81B of the first absorption layer 81.

In the instance shown in FIG. 21, there exist a plurality of intermediate openings 900 (openings 84B) in the first turbulent-flow generation area 9, and a plurality of intermediate openings 900 (openings 82B) also in the second turbulent-flow generation area 9. In such a case, a total of opening areas of the plurality of intermediate openings 900 is set smaller than the opening area of the one-side opening 910 and moreover smaller than the opening area of the other-side opening 920.

That is, in the first turbulent-flow generation area 9, the total of opening areas of the plural openings 84B is set smaller than the opening area of the opening 85B and smaller than the opening area of the opening 83B. In the second turbulent-flow generation area 9, the total of opening areas of the plural openings 82B is set smaller than the opening area of the opening 83B and smaller than the opening area of the opening 81B.

In addition, the opening area of the intermediate opening 900 needs only to be smaller than the opening area of the one-side opening 910 and smaller than the opening area of the other-side opening 920. However, as the opening area of the one-side opening 910 and the opening area of the other-side opening 920 each become closer and closer to the opening area of the intermediate opening 900, the separation effect of flushing ink from the gas flowing along the suction airflow path 70 becomes smaller and smaller. On the other hand, as the opening area of the intermediate opening 900 becomes smaller and smaller relative to each opening area of the one-side opening 910 and the other-side opening 920, the flowing resistance of suction airflows between the one-side opening 910 or the other-side opening 920 and the intermediate opening 900 increases more and more.

Accordingly, in this embodiment, the opening area of the intermediate opening 900 is set smaller than a half of the opening area of the one-side opening 910 and moreover smaller than a half of the opening area of the other-side opening 920. More preferably, the opening area of the intermediate opening 900 is set smaller than a third of the opening area of the one-side opening 910, and moreover the opening area of the other-side opening 920 is set also smaller than a third of the opening area of the one-side opening 910. As a result, the separation effect of flushing ink becomes more likely to be obtained at a border between the one-side opening 910 and the intermediate opening 900, as well as at a border between the intermediate opening 900 and the other-side opening 920.

Also in this embodiment, the absorption member 8 is placed in the storage area of the waste ink container 7, and a plurality of suction airflow paths 70 are formed by spaces of the storage area where no absorption member 8 exists. Therefore, the collection efficiency of flushing ink can be enhanced without difficulty. However, it is also allowable that a member which is less capable of absorbing ink than the absorption member 8 or which is incapable of absorbing ink is placed in the storage area of the waste ink containers 7 so that a plurality of suction airflow paths 70 are formed of the member.

### Reverse Airflow Paths and Forward Airflow Paths

In this embodiment, such suction airflow paths 70 as shown in FIGS. 12 to 14 are provided. In FIGS. 12 to 14, the suction airflow paths 70 are schematically shown by broken-line arrows. In FIGS. 12 to 14, flowing directions of suction airflows are depicted by broken-line arrows. A suction airflow path 71 ranging from the central reception hole 711 to the suction hole 730 is schematically shown by broken-line arrow in FIG. 12, a suction airflow path 72 ranging from the front-side reception hole 712 to the suction hole 730 is schematically shown by broken-line arrow in FIG. 13, and a suction airflow path 73 ranging from the rear-side reception hole 713 to the suction hole 730 is schematically shown by broken-line arrow in FIG. 14.

In this embodiment, the suction airflow paths 71 to 73 each have a reverse airflow path 70R and a forward airflow path 70F. The reverse airflow path 70R is an airflow path that leads a suction airflow for further separation from the suction hole 730 as viewed in the up/down direction. The forward airflow path 70F is an airflow path that leads a suction airflow for further nearness to the suction hole 730 as viewed in the up/down direction.

In this embodiment, by the reverse airflow path 70R and the forward airflow path 70F being provided among the suction airflow paths 70, flowing paths for suction airflows ranging from reception hole 710 to suction hole 730 are elongated. Elongated flowing paths for suction airflows lead to increases in absorption opportunity of flushing ink into the inner walls (i.e., absorption member 8) of the suction airflow path 70.

As a result of this, in this embodiment, separation of flushing ink from a gas flowing along the suction airflow path 70 is successfully carried out. In other words, absorption quantity of flushing ink into the inner walls of the suction airflow path 70 is increased, so that the collection efficiency of flushing ink in the storage area of the waste ink container 7 is enhanced. Thus, leakage of the flushing ink from the waste ink container 7 can be suppressed. Enabled suppression of leakage of the flushing ink from the waste ink container 7 makes it practicable to suppress occurrence of such disadvantages as in-apparatus (e.g., suction mechanism 10) contamination with flushing ink.

Also in this embodiment, the suction airflow path 70 allows the flowing direction of suction airflows to be bent a plurality of times from horizontal to up/down direction. As a result, absorption opportunities of flushing ink into the inner walls (i.e., absorption member 8) of the suction airflow path 70 can be further increased.

Also in this embodiment, at least two suction airflow paths 70 out of plural suction airflow paths 70 (71 to 73) merge together before reaching the suction hole 730. More specifically, the suction airflow paths 71 and 72 merge with each other before reaching the merging chamber 720, then reaching the suction hole 730. Further, the suction airflow paths 71 to 73 merge with one another at the merging chamber 720, then reaching the suction hole 730. That is, the suction airflow paths 71 to 73 merge with one another before reaching the suction hole 730.

With this configuration, it becomes implementable to reduce spaces for formation of the suction airflow paths 70 in the storage area of the waste ink container 7. Thus, any upsizing of the waste ink container 7 can be suppressed.

The embodiment disclosed herein should be construed as not being limitative but being an exemplification at all points. The scope of the disclosure is defined not by the above description of the embodiment but by the appended claims, including all changes and modifications equivalent in sense and range to the claims.

What is claimed is:

1. An inkjet recording apparatus comprising:
a recording head for ejecting ink to a recording medium, which is being conveyed toward one side of a first direction, to record an image;
a waste ink container which is placed so as to be opposed in a second direction to the recording head with a conveyance path for the recording medium interposed therebetween and which internally has a storage area to store the ink, which has been ejected from the recording head, in the storage area; and
a suction mechanism for sucking a gas from the waste ink container, wherein
the waste ink container includes:
a reception hole for receiving the ink ejected from the recording head;
a suction hole which is placed at a position separate by a spacing from the reception hole as viewed in the second direction and which is connected to the suction mechanism; and
a suction airflow path which communicates with the reception hole and the suction hole so as to allow a suction airflow generated by drive of the suction mechanism to pass therethrough, and
the suction airflow path includes, as viewed in the second direction:
a reverse airflow path for leading the suction airflow in a direction of further separation from the suction hole; and
a forward airflow path for leading the suction airflow in a direction of further nearness to the suction hole.

2. The inkjet recording apparatus according to claim 1, wherein
the suction airflow path has a flowing direction for the suction airflow bent toward the second direction at plural times.

3. The inkjet recording apparatus according to claim 1, wherein
the reception hole is provided in plurality in the waste ink container,
the suction airflow path is provided in plurality in the waste ink container,
the suction hole is placed at a position separate by a spacing from each of the plural reception holes as viewed in the second direction,
the plurality of suction airflow paths are connected to their mutually different reception holes, respectively, to communicate the connection-destination reception holes and suction holes with each other, and
at least two suction airflow paths out of the plurality of suction airflow paths merge together before reaching the suction holes.

4. The inkjet recording apparatus according to claim 1, wherein
the waste ink container has, in the storage area, an absorption member capable of absorbing the ink, and
the suction airflow path is defined by a space out of the storage area in which the absorption member is absent.
